(19) United States
(12) Patent Application Publication
(10) Pub. No.: US 2005/0024705 A1
(43) Pub. Date: Feb. 3, 2005

(54) Photopolymerizable electrolyte layers for electrochromic windows

(76) Inventors: William Freeman, Castro Valley, CA (US); David Rosseinsky, Exeter (GB); Hong Jin Jiang, Singapore (SG); Andrew Soutar, Singapore (SG)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/759,261

(22) Filed: Jan. 19, 2004

Related U.S. Application Data
(63) Continuation-in-part of application No. 10/700,969, filed on Nov. 4, 2003, now abandoned.
(60) Provisional application No. 60/423,958, filed on Nov. 4, 2002.

(51) Int. Cl. G02F 1/15

(52) U.S. Cl. 359/275; 156/99; 156/275.5

(57) ABSTRACT

The invention relates generally to a new type of electrochromic (EC) window, and a method of manufacturing the same. The EC window of the present invention utilizes a photopolymerizable monomer in a liquid-like solution to allow the entire solution to be cured to a substantially solid form using light instead of heat. The EC window includes a first plate layer, a first conductive layer, a guest host electrolyte/electrochromic layer, a second conductive layer, and a second plate layer. The photopolymerizable monomer may be included in either the guest-host electrolyte or the electrochromic layer

### CROSS-REFERENCE TO RELATED APPLICATIONS

The present application is a continuation-in-part application of U.S. patent application Ser. No. 10/700,969, filed on Nov. 4, 2003 and entitled “Photopolymerizable Electrolyte Layers for Electrochromic Windows”, which claims priority to U.S. Provisional Patent Application No. 60/423,958, filed on Nov. 4, 2002, and entitled “Photopolymerizable Electrolyte Layers for Electrochromic Windows”, both of which are incorporated herein by reference in their entireties.

### BACKGROUND OF THE INVENTION

1. The Field of the Invention

This invention relates generally to the field of optical attenuation devices for use in optical systems. In particular, embodiments of the present invention relate to an electrochromic window using photopolymerizable electrolyte layers and a method of manufacturing the same.

2. The Relevant Technology

Fiber optics is increasingly used for transmitting voice and data signals. As a transmission medium, light provides a number of advantages over traditional electrical communication techniques. For example, light signals allow for extremely high transmission rates and very high bandwidth capabilities, up to 30,000 GHz for single mode fibers. Light signals can also be conducted over greater distances without the signal loss typically associated with electrical signals on a copper conductor, by at least an order of magnitude.

Light signals propagating along an optical fiber are resistant to electromagnetic interference that would otherwise interfere with electrical signals. Furthermore, use of light signals to carry data is more secure than electrical signals because it is more difficult to access the data carried within propagating light signals than data carried by electrical signals. For instance, propagating light does not emanate the type of high frequency components often experienced with conductor-based electrical signals. Although it is possible to siphon some portion of the light from a fiber by bending the fiber, this process is complicated and difficult to perform.

Many conventional electrical networks are being upgraded to optical networks to take advantage of the increased speed, efficiency, and security. Optical communication networks use lasers to create light that is then modulated to convey information. One of the many components of an optical communications network is an optical attenuator. Optical attenuators control the intensity of one or more wavelengths of light within an optical system.

On occasion, it is necessary to recalibrate or replace one or more of the lasers generating light in the system. To avoid data corruption, it is usual to completely extinguish the laser's light from the optical system before recalibration or replacement. Optical attenuators are capable of extinguishing the laser's light by blocking it from entering the remainder of the optical system. There are numerous general methods of attenuating or completely preventing light from passing through a medium.

In addition to attenuating the light incident upon an optical system, it is often desirable to control the intensity of a particular wavelength or channel of light entering a fiber. For instance, certain optical devices only operate with defined ranges of light intensity. One manner used to control the light intensity is to simply adjust the electrical current feeding a laser to adjust its output intensity. However, it is not desirable to make such adjustments because this method of attenuation will affect the bandwidth capabilities of the laser. Therefore, it is necessary to use a variable optical attenuator to attenuate or adjust the output intensity of a particular laser.

Clearly, one can attenuate the light on either the transmit side or the receive side of the optical device. Attenuating on the receive side requires only local feedback, as opposed to having to communicate with the transmitter on the other end of the fiber. In general, only fixed attenuation is required on the transmit side so long as one has the ability to turn the transmitter off. Variable attenuation is desirable on the receive side because of the unpredictability of the intensity of the incoming signal.

One type of attenuator uses an electrochromic (EC) window to attenuate light transmitted through the window. An EC window attenuates the amount of light passing through the window as a function of the input voltage applied to or across the window. This type of attenuator does not use moving parts nor does it change the polarization of the incoming light in any way. An EC window utilizes a particular crystalline structure that reflects and refracts light in such a way as to attenuate the light when a voltage is applied across two electrically conducting layers within the window.

EC windows generally must be manufactured individually on a very small scale because of problems with subdividing large EC windows. One of the standard techniques for producing EC windows involves dissolving an electrolyte and a polymer in a solvent. This combination is then spread between two conductive layers which are located between two pieces of glass to form a stack. The stack is then baked at a high temperature to remove the solvent and solidify the outer edges of the solution, while leaving the remainder of the solution in a gel-like form. In the event that the EC window was to be sub-divided into smaller pieces, the electrochromic and electrolyte solution exits from between the glass layers because the edges would no longer be sealed on all sides.

In addition to possible leaking, the process of heating the EC window causes other problems that affect the overall optical performance. Bubbles formed in the original electrochromic and electrolyte solution during heating solidify. The undesired bubbles formed in the solution refract light that is transmitted through the EC window causing unwanted optical affects that degrade the overall performance of the EC window.

In addition to bubble formation, a portion of the solution could also partially leak from the glass layers before it is heated or cured. The amount of electrochromic and electrolyte solution affects the characteristics of the final EC window and therefore any leakage could negatively change the properties of the EC window. It is also possible for the electrochromic and electrolyte solution to dry out over time causing the optical properties of the EC window to drift. Yet another problem with the conventional manufacturing of EC windows is that during the heating process the glass layers may bow slightly in response to the heat. The bowing of the glass will also change the optical properties of the EC window by acting like a lens rather than a window.

### BRIEF SUMMARY OF THE INVENTION

The invention relates generally to a new type of electrochromic (EC) window. The EC window of the present invention utilizes a photopolymerizable monomer in a liquid-like solution to allow the entire solution to be cured to a substantially solid form using light instead of heat. In this manner, the entire solution can be cured, rather than only the peripheral edges as is typically the case.

According to one aspect, the EC window described herein can be much larger than conventional EC windows. The EC window can, therefore, be created at a lower cost than currently available EC windows.

According to another aspect, the EC window is capable of being subdivided into smaller sections without the possibility of material forming the EC window leaking. Each section of the EC window can function independently from the other sections as an optical attenuator or other device that facilitates reducing in the amount of light entering a system.

According to yet another aspect, the processes, methods, and techniques described herein eliminate the problems associated with the EC material leaking from an EC window during manufacture. By using a photopolymerizable monomer in association with the electrochromic/electrolyte layer of the EC window, all of the electrochromic/electrolyte layer can be substantially solidified. Additionally, use of the photopolymerizable monomer minimizes or eliminates changes in optical properties resulting from drift.

According to still another aspect, the processes, methods, and techniques described herein reduce the possibility of bowing or deforming the glass surfaces or layers surrounding the electrochromic/electrolyte layer and the conductive layers of the EC window. No heat is used to form the EC window.

An EC window can include a first plate and a second plate that is disposed from the first plate. These plates are transparent to at least one wavelength of electromagnetic radiation thereby allow certain wavelengths of electromagnetic radiation to pass through the plates. Disposed between the plates are a first electrically conductive layer and a second electrically conductive layer. Located between the conductive layers is an attenuation layer. This attenuation layer includes a layer of an at least partially cured photopolymerizable monomer that is mixed with an electrolyte and an electrochromic material. Alternatively, the attenuation layer can include separate an electrochromic and electrolyte layers.

To form the EC window, the attenuation layer is deposited upon at least one of the conductive layers. Following depositing the attenuation layer, electromagnetic radiation having a selected wavelength is passed through the conductive layers. This results in the monomer with the attenuation layer partially curing. The glass plates can subsequently be attached to the conductive layers.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A illustrates an exploded profile view of an electrochromic window optical attenuator system manufactured in accordance with one embodiment of the present invention;

FIG. 1B illustrates a profile view of an electrochromic window optical attenuator system manufactured in accordance with an alternate embodiment of the present invention;

FIG. 2 shows a graph of the relationship between voltage and attenuation in an electrochromic window in accordance with an alternate aspect of the present invention;

FIG. 3A shows a basic exemplary apparatus for using embodiments of the present invention;

FIG. 3B shows the apparatus of FIG. 3A in a header package; and

FIG. 4 is a block diagram illustrating one method of manufacturing an electrochromic window according to one aspect of the present invention.

### DETAILED DESCRIPTION OF THE EXEMPLARY EMBODIMENTS

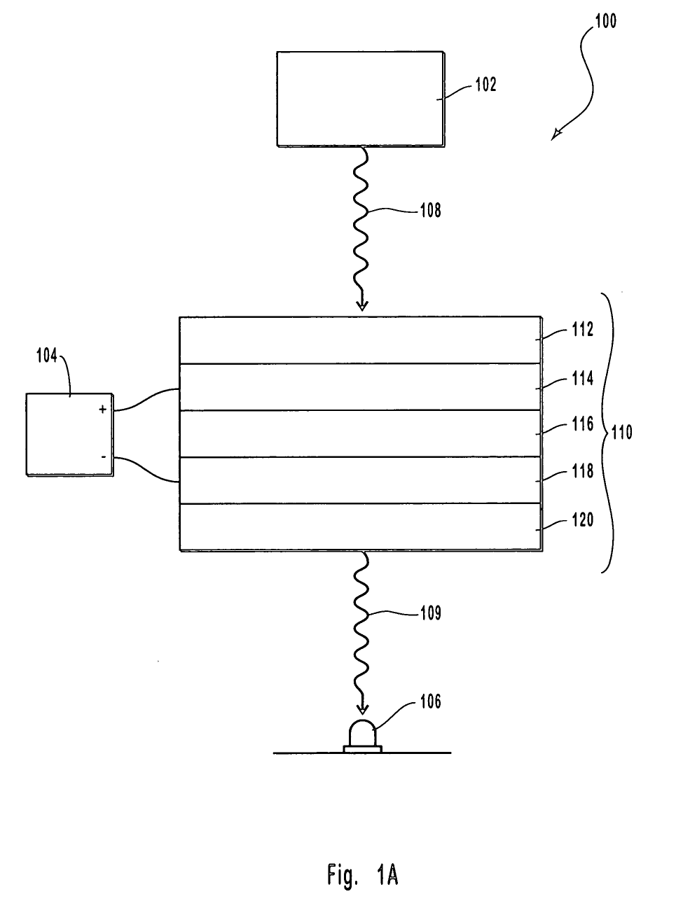

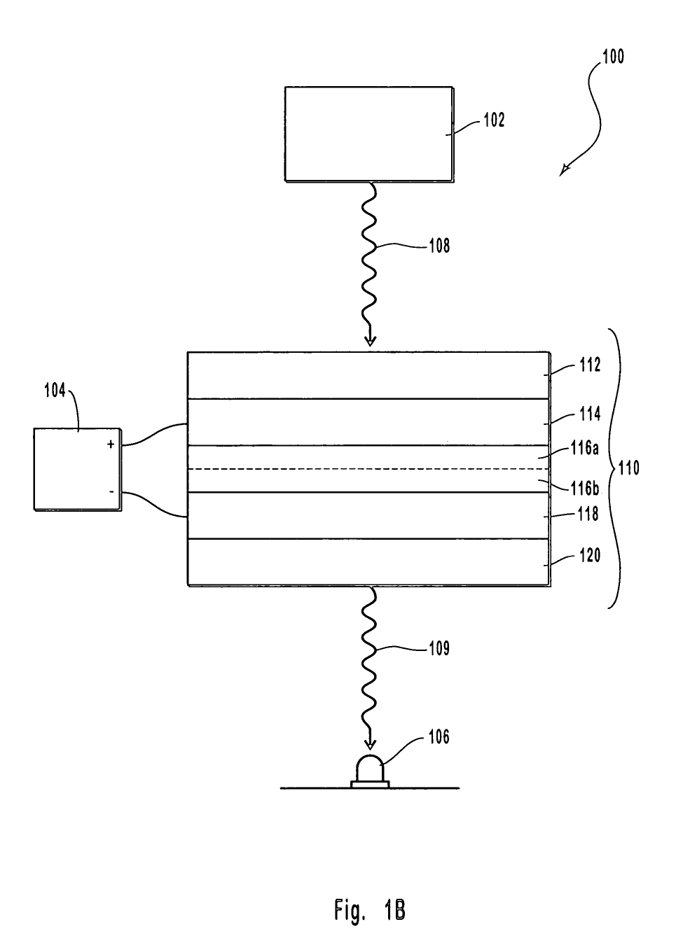

Reference will now be made to the drawings to describe exemplary embodiments of the invention. It is to be understood that the drawings are diagrammatic and schematic representations of the exemplary embodiments, and are not limiting of the present invention, nor are they necessarily drawn to scale. For FIGS. 1A and 1B, identical numbers are used to refer to identical parts within the two embodiments.

In general the present invention relates to a new type of electrochromic (EC) window and a method of manufacturing such a window. The structure of the EC window and the method of manufacture enable forming of larger EC windows than are currently possible. Further, the structure of the EC window lends itself to simply sub-dividing into smaller EC windows. To aid in forming such large sub-dividable EC windows, a photopolymerizable material is used to bind the electrochromic and electrolyte chemical composition forming part of the EC window. This is in contrast to existing EC windows that use a solvent. By incorporating the photopolymerizable material, curing of the EC window occurs with specific wavelengths of electromagnetic radiation rather than by heating.

While embodiments of the present invention are described in the context of an EC window used for optical attenuation in optical networking, it will be appreciated that the teachings of the present invention are highly useful to other applications as well. For example, EC windows can occasionally be used in place of traditional architectural glass windows to attenuate sunlight at particular times of the day or in response to temperature.

FIG. 1A illustrates a schematic representation of an optical attenuator system 100 in accordance with one embodiment of the present invention. The system 100 includes a laser 102, a power supply 104, a photodiode 106, and an EC window 110.

The laser 102 generates electromagnetic radiation or waves, such as a light signal 108, which digitally encodes information on one or more wavelength channels. The laser 102 can be any laser source, such as, but not limited to, gas and semiconductor based lasers. The light signal 108 is transmitted from laser 102 into EC window 110 in the manner shown. Alternately, light signal 108 need not come from laser 102, but can be an incoming signal transmitted across a fiber-optic network, or any other incoming signal that can require attenuation before being transmitted to an optical receiver or photodiode.

The EC window 110 attenuates light signal 108 by a specified amount to lower the overall power or intensity of light signal 108. This does not affect the digital information encoded within the channels of light signal 108. Attenuation may include blocking a certain percentage of the overall light signal's power as opposed to blocking or filtering specific wavelengths of a light signal. The EC window 110 can attenuate light signal 108 by an amount mathematically related to the amount of voltage applied oz e upon it from the power supply 104. As a voltage is applied to EC window 110, the attenuation level changes.

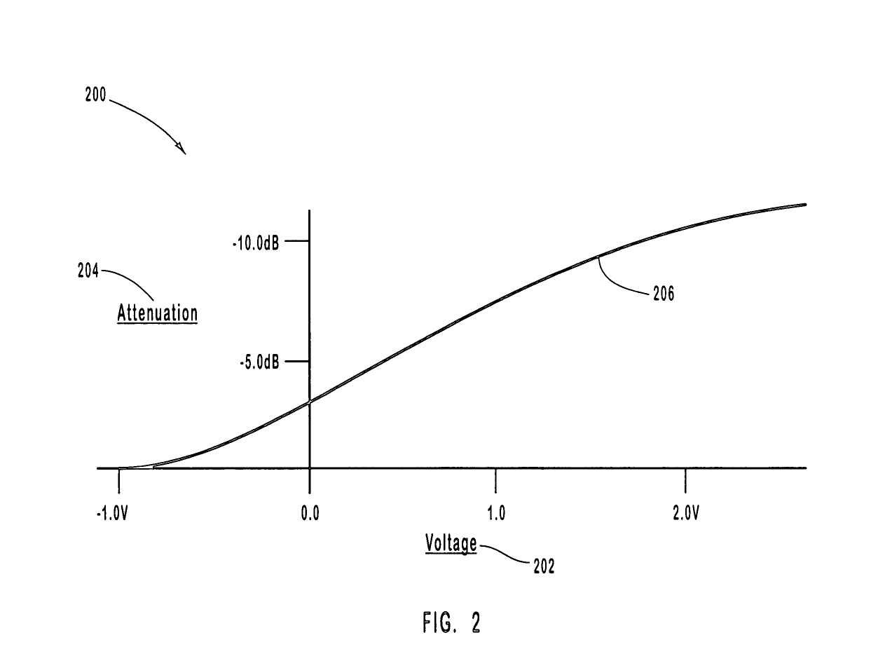

A graph showing one general relationship between the attenuation level and the voltage applied is shown in FIG. 2, and designated generally as 200. The relationship between voltage 202 and attenuation 204 is illustrated as being somewhat linear, but a line 206 indicating this relationship does not pass through zero, as the graph of FIG. 2 suggests. It will be understood that other attenuation levels are possible, as well as other graphical representations of the relationship between voltage and attenuation that are non-linear.

Referring again to FIG. 1A, power supply 104 connects to EC window 110 and generates a voltage that operates EC window 110. The power supply 104 can be any electrical circuit that generates the desired voltage. The power supply 104 can include microprocessors, sensors, feedback loops, etc to facilitate efficiently applying the exact voltage on EC window 110. The higher the voltage applied to EC window 110, the larger the amount of light attenuation generated by EC window 110.

In one configuration, EC window 110 can be completely compatible with 3.3V systems and can draw almost no current. This low current feature allows the conductive coatings or layers forming EC window 110, as will be described in detail hereinafter, to have rather high impedance, up to 500Ω. Other EC windows can be compatible with other voltage systems and draw varying currents. Electrically, EC windows 110 can be thought of like a capacitor with a small leakage current, while electrochemically, EC window 110 can be viewed much like a battery, or for those familiar with them, like an electrolytic capacitor. Therefore, EC window 110 changes color based upon a field induced ionic transfer.

With continued reference to FIG. 1A, the un-attenuated portion of light signal 108 incident upon EC window 110 passes through EC window 110 and is incident upon photodetector 106. This un-attenuated light signal is identified as reference numeral 109. The photodetector 106 may be an optical device that measures the power of light signal 109. The photodetector 106 can be used to convert the light signal 109 into an electrical data signal. Alternatively, light signal 109 can also be transmitted to another location in addition to photodetector 106.

Generally, photodetector 106 can decode light signals that are within a particular power range. In order to ensure that light signal 108 transmitted from laser 102 conforms to a particular power range, EC window 110 can be set to attenuate light signal 108 by an amount that will ensure that light signal 109 is within the operable range of photodetector 106. The power supply 104 can be set to supply a voltage across EC window 110 that will attenuate light signal 108 by the appropriate amount.

With continued reference to FIG. 1A, EC window 110 further includes a first clear plate layer 112, a first conductive layer 114, an attenuation layer 116, a second conductive layer 118, and a second clear plate layer 120. The clear plate layers 112, 120 allow light signals to pass therethrough. For instance, first clear plate layer 112 allows light signal 108 to enter EC window 110, while second clear plate layer 120 allows light signal 109 to exit from EC window 110. In one exemplary configuration, plate layers 112, 120 are glass plates coated with an indium tin oxide (ITO) clear conductive layer. While ITO is clear in the visible range, it is less clear in the near IR. Thus, the extremely low current draw of ECs allows the conductive ITO coating to be very thin and thus minimize the absorption.

Clear plate layers 112, 120 can have a thickness between about 100 μm and 1000 μm. Alternately, the clear plate layers 112, 120 may be constructed from quartz, various crystals or any other approximately clear material capable of passing light at the required wavelengths, and which can be cut or diced into smaller window components. Further, clear plate layers 112, 120 can include coatings to reduce reflections, filter unwanted wavelengths, or perform other actions to incident or transmitted light.

The conductive layers 114, 118 are used to apply the voltage across the attenuation layer 116. The conductive layers 114, 118 can be formed from a material capable of passing the wavelength of light needed to cure the photopolymerizable material discussed below, and the light signals that EC window 110 of the attenuator is designed to affect. The conductive layers 114, 118 can be formed on clear plate layers 112, 120 or can be separate conductive layers attached thereto. Generally, conductive layers 114, 118 can be any conductive material, such as, but not limited to, metals, alloys, etc.

The attenuation layer 116 includes a chemical composition that generally absorbs light in a particular manner when an electrical voltage is applied across it. This attenuation layer 116 can include a guest host type electrolyte mixture with electrochromic material. The purpose of the guest host electrolyte layer is to provide a transport medium for the ions, usually lithium ions, which will transport the charge to the counter electrode. The electrochromic layer provides the material that actually attenuates light signal 108 when a voltage is applied across conductive layers 114, 118.

In this exemplary embodiment, the guest host electrolyte and electrochromic compounds are mixed together and applied as a single attenuation layer 116. In this exemplary embodiment, the attenuation layer 116 is a mixture of Prussian blue-tungsten trioxide, which has the desirable feature that attenuation layer 116 is therefore electrochromic. When a voltage is applied, the Prussian blue turns blue and the tungsten trioxide (WO₃) turns brown. Frequently, only one of the electrolyte layer and the electrochromic layer is electrochromic and the other is clear. In this exemplary embodiment, in order to obtain as much attenuation as possible, the attenuation layer is electrochromic.

Alternately, as shown in FIG. 1B, a guest host electrolyte layer 116a and an electrochromic layer 116b may be applied separately as individual, distinct compounds. For purposes of the invention, it makes no difference which layer is applied first. They can be applied to the same surface, first one then the other in any order. Alternately, they can be applied to conductive layers 114, 118 separately. For instance, guest host electrolyte layer 116a can be applied onto conductive layer 114, while electrochromic layer 116b can be applied onto conductive layer 118. The electrolyte layer 116a can be one of a variety of solid state electrolytes such as zirconium phosphate. The electrochromic layer can be, by way of example and not limitation, ferric-ferricyanide, NiO, or WO₃.

Regardless of whether the guest host electrolyte layer and electrochromic layers are applied as a single solution 116, or separate compounds 116a, 116b, the layer includes a photopolymerizable monomer. This monomer bonds the two layers to one another and the surrounding conductive layers 114, 118 when it cures under the influence of a particular wavelength of light. A photopolymerizable monomer is material that can be cured or solidified with a particular wavelength of light rather than heat. Photopolymerizable monomers can be, by way of example and not limitation, polymethylmethacrylate, or methylpentene, or any material which can be crosslinked and can transmit near infrared light signals without too much attenuation. Each of these compounds is specifically designed to polymerize at a particular wavelength of light. For instance, polymethylmethacrylate is polymerized by light at wavelengths below 350 nm.

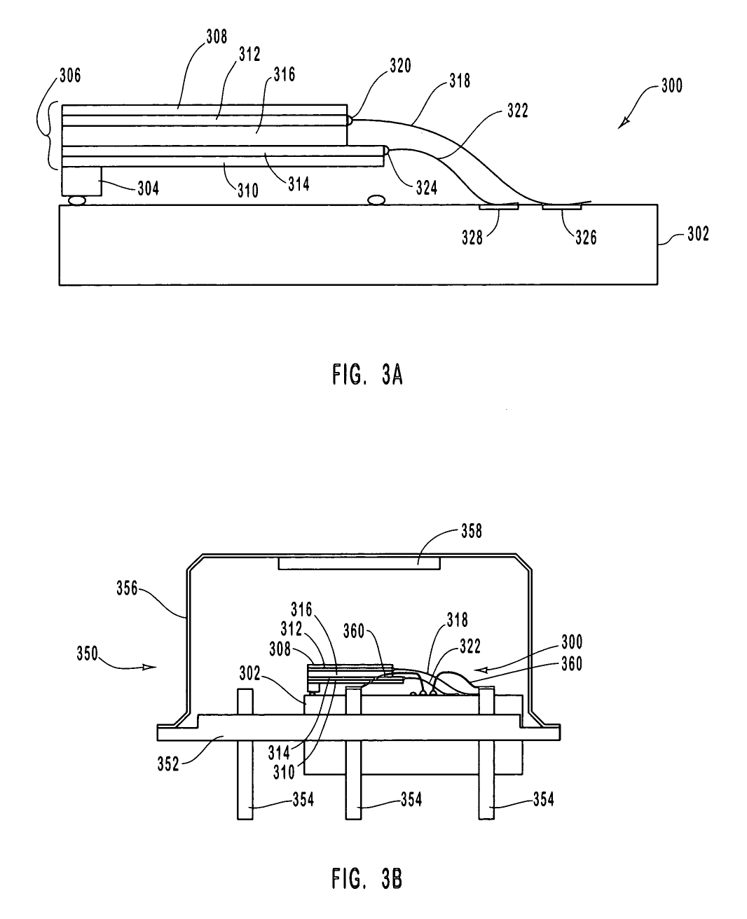

One exemplary embodiment of a system that uses an exemplary EC window of the present invention is illustrated in FIGS. 3A and 3B. FIG. 3A shows a very basic version of a receiver optical sub-assembly (ROSA), which is designated generally as reference numeral 300. ROSA 300 includes a preamp 302, a photodiode 304, an EC window 306, and electrical connectors 318, 322 that provide power to EC window 306.

Preamp 302 can be a trans-impedance amplifier (TIA), or other type of amplifier used to receive and process electrical signals. Preamp 302 can optionally include control circuitry (not shown) to adjust the amount of current sent to EC window 306 in order to adjust the attenuation level. The control circuitry can also be external to ROSA 300, such that preamp 302 receives control signals from an external source through one or more pins, such as but not limited to pins 354 illustrated in FIG. 3B.

With continued reference to FIG. 3A, preamp 302 can include various electrical connections for photodiode 304, EC window 306, and/or other electrical components (not shown). Since models and designs of preamps vary with manufacturer and intended use, those skilled in the art will realize that numerous types of preamps can be operated successfully in ROSA 300.

Photodiode 304 can be any of various types of photodiodes known to those skilled in the art. Photodiode 304 receives optical signals from, for example, a fiber optic network connection, and converts these signals into electrical signals. The electrical signals are then processed by preamp 302. Alternately, preamp 302 sends the signals to other electrical components (not shown). In this exemplary embodiment, photodiode 304 can only decode light signals that are within a particular power range. Therefore, in order to ensure that a light signal entering photodiode 304 conforms to this requirement, EC window 306 is set to attenuate the light signal by an amount that will ensure that the light signal is within the operable range of photodetector 304.

EC window 306 can be a portion of EC window 110 (FIGS. 1A and 1B). The EC window 306 can include two spaced apart clear plate layers 308, 310 and two conductive layers 312, 314 that surround an attenuation layer 316. Each the layers can have a similar configuration to the layers described with respect to FIGS. 1A and 1B and 2.

Electrical connecting EC window 306 to preamp 302 is electrical connectors 318 and 322. The electrical connector 318 extends from an electrode 320 attached to first conductive layer 312 to an electrical contact 326 formed on preamp 302. Similarly, electrical connector 322 extends from an electrode 324 attached to second conductive layer 314 to an electrical contact 328 formed on preamp 302. In exemplary embodiments, the conductive material forming conductive layers 312, 314 in EC window 306 is metallized, indium tin oxide (ITO), while the conductive material forming electrodes 320, 324 is gold bonded to the metallized section. Other types of metals or conductive materials can also be used.

FIG. 3B shows ROSA 300 of FIG. 3B installed in a header package, which is designated generally as reference numeral 350. Header package 350 can be a transistor outline (TO) header package, or any of the various other types of header packages known to those of skill in the art. The ROSA 300 mounted in header package 350 can be used to attenuate light signals incident upon header package 350 anywhere in a range from about 800 nm to about 1700 nm. Depending on the specific construction and properties of EC window 306, other ranges are also possible.

In addition to the components of ROSA 300 discussed above, header package 350 can include a base member 352 that supports ROSA 300 and the other parts of header package 350. Extending from base member 352 are various electrical connections or pins 354. Pins 354 can include, by way of example and not limitation, a ground connection, positive and negative electrical connections, and various control connections. Pins 354 can be fabricated from a variety of conductive materials, such as metals, alloys, etc. This pins 354 can cooperate with various other electrical devices so that control signals can be passed to preamp 302 and/or received data can be delivered to the other electrical devices.

The pins 354 connect to ROSA 300, and more specifically to preamp 302 via electrical connectors 360. Connectors 360 can have a similar configuration to connectors 318 and 322 described herein. Further other connectors known to those skilled in the art are applicable.

Mounted to base member 352, and surrounding ROSA 300, is a cap 356. This cap 356 includes window 358 through which pass electromagnetic radiation, such as light signals having a specific wavelength. Cap 56, as well as base member 352, can be made from metal, plastic and other materials that provide the desired strength and protection to ROSA 300. The window 358 can be clear plastic, glass, or other clear materials capable of passing data carrying light signals. Additionally, window 358 can have various optical coatings applied to it, such as an antireflective coating, to facilitate the passage of light signals therethrough.

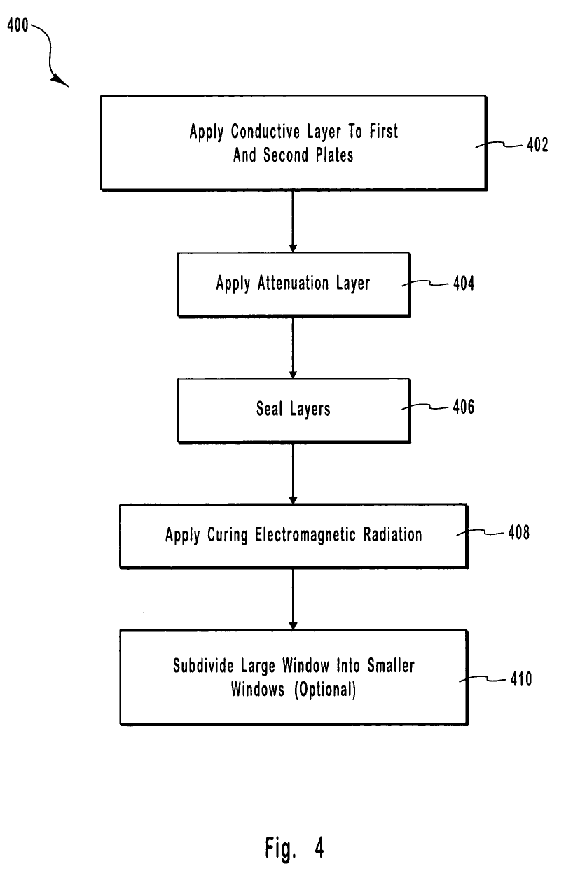

An exemplary method of manufacturing EC window 110 illustrated in FIGS. 1A and 1B is outlined in FIG. 4, and is designated generally as 400. Method 400 includes the steps of initially positioning a conductive material on both first plate layer 112 and second plate layer 120 to form first and second conductive layers 114, 118, as represented by block 402.

The conductive material may be a liquid-like material that instantly bonds to plates 112 and/or 120. Such a material could include ITO, or fluorinated tin oxide (FTO). The conductive coatings are generally formed by pulsed vapor deposition or sometimes sol-gel methods, although other methods or techniques of applying a coating to a substrate are known. The FTO has shown some improved adhesion properties for Prussian blue. In another configuration, a pre-formed sheet of the conductive material can be applied to plates 112 and/or 120 rather than using a pulse vapor deposition. This sheet can be constructed of any material with electrically conductive properties that is transparent to the appropriate wavelengths of light and capable of being applied as a thin coating on plate 112 and/or plate 120. The sheet can optionally be preformed to the shape of plates 112 and/or 120.

Following formation of conductive materials or layers upon plates 112 and/or 120, attenuation layer 116 containing an electrochromic/guest host solution and the photopolymerizable monomer is spread evenly across one or both conductive layers 114, 118, as represented by block 404. The chemicals that make up electrochromic/guest host electrolyte layer 116 can be evenly deposited onto second plate layer 120 or first plate layer 112 in a liquid-like form. A liquid-like form is a state in which the composition can include properties of a liquid, no mater the viscosity of such a liquid. Such an electrochromic/guest host layer might include photopolymerizable fluorinated polymers, sol-gels, methylmethacrylate and/or various polymers with vinyl groups attached.

Alternatively, electrochromic layer 116a can be a pre-formed solid material that is separate from guest-host electrolyte layer 116b. In this alternative embodiment, guest-host electrolyte layer 116b would include a photopolymerizable monomer because it is the layer to be cured. In still another embodiment, attenuation layer 116 (FIG. 1A) is a pre-formed solid material including the electromagnetic material, a guest-host electrolyte, and the photopolymerizable monomer.

Following positioning of attenuation layer 116, plate layers 112, 120 are then fixed together in a precise manner so as to ensure proper spacing and thickness of the electrolyte layer. The plate layers 112, 120 are then sealed, as represented by block 406 and the photopolymerizable monomer within attenuation layer 116 is cured, as represented by block 408. More specifically, the curing light source (not shown) is positioned to transmit a constant light signal of a particular wavelength through EC window 110 for a specified amount of time in order to cure the liquid-like materials between plate layers 112, 120.

The wavelength of the light source is specifically tuned to match the wavelength necessary to cure to the photopolymerizable monomer within attenuation layer 116. In an exemplary embodiment of the present invention, the photopolymerizable monomer is selected such that the wavelength of light required to cure the monomer is not too heavily absorbed by the conductive coatings on the glass. This process ensures that all of the liquid-like materials are cured into a substantially solid form.

Polymerization of the photopolymerizable monomer may result in some shrinkage of attenuation layer 116. The attenuation layer 116, however, applies tension uniformly on the surfaces of plate layers 112, 120 so that no bowing or warping of plate layers 112, 120 occur. Exemplary embodiments of the present invention may allow attenuation layer 116 to have sufficient adhesion to plate layers 112, 120 so that the layers do not separate.

Once the photopolymerizable monomer within attenuation layer 116 is cured to the desired degree, EC window 110 can optionally be sub-divided into smaller EC windows, as represented by block 410. These smaller EC windows having the same attenuation characteristics as the larger EC window.

The process as described above may produce an EC window with dimensions of about two centimeters square to around 10 cm. square. The technique can be improved to enable larger, possibly much larger, EC windows to be produced. This window may then be subdivided into smaller millimeter sized windows for applications in fiber optic transceivers. Optionally, the large window thus formed may then be subdivided into smaller EC windows, as represented by block 410.

The method of manufacturing an EC window of the present invention is more economically efficient and produces higher quality EC windows than conventional manufacturing techniques. Conventional methods of manufacturing EC windows utilize a heat based curing process that degrades the overall optical performance of the EC window by introducing anomalies such as bubbling, leakage, drift, and glass bowing. In addition, conventionally manufactured EC windows cannot be efficiently subdivided into smaller EC windows because of the uncured liquid-like electrochromic layer and/or electrolyte layer within the window.

The method of manufacturing EC windows of the present invention avoids all of the performance problems discussed above and provides the ability to manufacture multiple EC windows on a large scale rather than an individual scale. This is accomplished by ensuring that all of the liquid-like materials within the EC window are substantially cured into a solid form.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An electrochromic window comprising:
a first plate and a second plate disposed from said first plate, each of said first plate and said second plate being transparent to at least one wavelength of electromagnetic radiation;
a first electrically conductive layer and a second electrically conductive layer, said first electrically conductive layer being attached to said first plate and said second electrically conductive layer being attached to said second plate; and
an attenuation layer disposed between said first electrically conductive layer and said second electrically conductive layer, said attenuation layer comprising a layer of an at least partially cured photopolymerizable monomer mixed with an electrolyte and an electrochromic material.

2. The electrochromic window of claim 1, wherein said first plate and said second plate comprise a glass.

3. The electrochromic window of claim 1, wherein said first conductive layer and said second conductive layer are transparent to at least one wavelength of electromagnetic radiation.

4. The electrochromic window of claim 1, wherein said photopolymerizable monomer comprises one of polymethylmethacrylate and methylpentene.

5. The electrochromic window of claim 1, wherein said attenuation layer attenuates electromagnetic waves that pass through said attenuation layer.

6. The electrochromic window of claim 1, wherein said attenuation layer comprises an electrochromic layer and an electrolyte layer coupled to said electrochromic layer.

7. The electrochromic window of claim 1, wherein said attenuation layer attenuates electromagnetic waves that pass through said attenuation layer based upon a voltage between said first electrically conductive layer and said second electrically conductive layer.

8. An electrochromic window comprising:
a first plate having an inside surface;
a second plate disposed from said first plate, said second plate having an inside surface;
an electrically conductive layer adjacent said inside surface of each of said first plate and said second plate; and
an attenuation layer disposed between said first plate and said second plate, said attenuation layer comprising an electrochromic material, a guest-host electrolyte, and an at least partially curable photopolymerizable monomer.

9. The electrochromic window of claim 8, wherein said first plate and said second plate comprise glass.

10. The electrochromic window of claim 8, wherein said first plate and said second plate are transparent to at least one wavelength of electromagnetic radiation.

11. The electrochromic window of claim 8, wherein the photopolymerizable monomer comprises one of polymethylmethacrylate and methylpentene.

12. The electrochromic window of claim 8, wherein said guest-host electrolyte and said at least partially curable photopolymerizable monomer are in solution.

13. The electrochromic window of claim 8, wherein said electrochromic materials is in solution with said at least partially curable photopolymerizable monomer.

14. The electrochromic window of claim 8, wherein said guest-host electrolyte and said at least partially curable photopolymerizable monomer are in solution and form a first layer of said attenuation layer.

15. The electrochromic window of claim 14, wherein said electrochromic materials form a second layer of said attenuation layer.

16. A method of manufacturing an electrochromic window comprising:
a step for positioning at least one conductive layer, said at least one conductive layer being configured to substantially transmit a particular wavelength of electromagnetic radiation;
a step for depositing an attenuation layer upon said at least one conductive layer, wherein said attenuation layer comprises an electrolyte material, an electrochromic layer, and an at least partially curable photopolymerizable monomer, said monomer being cured by a first wavelength of electromagnetic radiation; and
a step for transmitting said first wavelength of electromagnetic radiation, through said at least one conductive layer, to said attenuation layer to at least partially cure said monomer.

17. The method of claim 16, further comprising a step for positioning at least one plate adjacent to said at least one conductive layer.

18. The method of claim 16, further comprising a step for positioning at least one plate to receive said at least one conductive layer.

19. The method of claim 16, wherein said step for depositing said attenuation layer comprises:
a step for depositing a first layer comprising said electrolyte and said at least partially curable photopolymerizable monomer; and
a step for depositing a second layer upon said first layer, said second layer comprising said electrochromic material.

20. The method of claim 16, wherein said step for depositing said attenuation layer comprises:
a step for creating a solution of said electrolyte and said at least partially curable photopolymerizable monomer; and
a step for depositing a first layer, said first layer comprising said solution; and
a step for depositing a second layer upon said first layer, said second layer comprising said electrochromic material.

21. The method of claim 16, wherein said step for depositing said attenuation layer comprises:
a step for creating a mixture of said electrolyte and said at least partially curable photopolymerizable monomer; and
a step for depositing a first layer, said first layer comprising said solution; and
a step for depositing a second layer upon said first layer, said second layer comprising said electrochromic material.

22. The method of claim 16, wherein said step for positioning said at least one conductive layer comprises applying a conductive liquid to at least one plate.

23. The method of claim 22, wherein said step for positioning said at least one conductive layer includes applying a solid sheet of conductive material upon at least one plate.

24. The method of claim 16, wherein the photopolymerizable monomer comprises one of polymethylmethacrylate and methylpentene.
